(19) United States
(12) Patent Application Publication
(10) Pub. No.: US 2010/0044979 A1
(43) Pub. Date: Feb. 25, 2010

(54) INDEPENDENT WHEEL SUSPENSION

(75) Inventors: Felix Haeusler, Osnabruck (DE); Simon Aramah, Osnabruck (DE); Knut Heidsieck, Bunde (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/447,938

(22) PCT Filed: Oct. 22, 2007
(86) PCT No.: PCT/DE07/01881

§ 371 Date: Apr. 30, 2009

(30) Foreign Application Priority Data
Nov. 3, 2006 (DE) 10 2006 052 252.4

(51) Int. Cl. B60G 3/26

(52) U.S. Cl. 280/5.521

(57) ABSTRACT

An independent wheel suspension for a motor vehicle in which at least a first and at least a second link arm are respectively articulated to a wheel carrier supporting a vehicle wheel. The independent wheel suspension includes a compensation unit for the correcting the wheel positions. The first and the second link arms either include or are connected to compensation units and at least two compensation units, of each wheel, are connected to one another by at least one coupling element. The wheel position of at least one of the vehicle wheels, that deviates from a neutral position, can be sensed by a sensor unit having a measured-value transmitter and receiver that are arranged on at least one of the compensation units of the vehicle wheel concerned, or associated with at least one of the compensation units.

This application is a National Stage completion of PCT/DE2007/001881 filed Oct. 22, 2007, which claims priority from German patent application serial no. 10 2006 052 252.4 filed Nov. 3, 2006.

### FIELD OF THE INVENTION

The invention concerns an independent wheel suspension.

### BACKGROUND OF THE INVENTION

As a result of stricter safety and comfort demands, disturbances that affect the wheel suspension have to be compensated for more quickly and to better and better effect. For example, the inclination of a vehicle wheel relative to the road surface varies due to the influence of lateral forces and rolling of the vehicle's body. The resulting vehicle wheel camber leads to a change of the tire contact area, so that the vehicle wheel adhesion to the ground decreases.

Previously known double transverse control arm axles compensate this camber tendency by controlled influencing of the wheel position, in that an oppositely directed, negative camber is produced which, for example when driving round a curve, can be achieved by varying the length or orientation of the transverse control arms. However, this has disadvantages when the motor vehicle is driving straight ahead, namely when individual vehicle wheels on one side bounce, as happens for example when driving over a bumpy surface. Furthermore, with such double transverse control arm suspensions, undesired tire wear takes place and valuable lateral force potential of the tire is lost.

EP 1 070 609 B1 describes a wheel suspension made as a double transverse control arm axle. The special feature of this solution is that a steering rocker is used as the compensation means, which forms an articulated connection between the ends of an upper and a lower link arm on the vehicle body side, so that both link arm ends are arranged on a common steering rocker. The opposite ends of these transverse control arms are in each case fixed to a wheel carrier.

Another wheel suspension for a motor vehicle is known from U.S. Pat. No. 6,929,271 B2. The wheel suspension described in that document has stabilizers as compensation means for the correction of wheel positions such as wheel camber, such that both a connection of two wheels opposite one another, i.e. the wheels on both sides of the vehicle, and also a coupling of the front with the rear wheels is provided. In this solution, as compensation means, dual-action piston-cylinder units integrated in the stabilizer of the motor vehicle are used, which, for example when driving round a curve, compensate undesired wheel movements. The wheel suspension known from U.S. Pat. No. 6,929,271 B2 has a transverse control arm which is articulated to a wheel carrier supporting a vehicle wheel.

The common feature of these known systems is that the forces acting on the vehicle wheels and the undesired displacement of the vehicle wheels resulting therefrom are compensated by coupling a plurality of vehicle wheels with one another, and to do this suitable compensation means are used.

Furthermore, DE 10 2006 006 513 A1 describes a wheel suspension for a motor vehicle, in which at least a first and at least a second link arm are each articulated to a wheel carrier supporting a vehicle wheel. The wheel suspension comprises compensation means for the correction of wheel positions, each link arm having compensation means or being connected to a compensation means and the compensation means of a vehicle wheel each being connected with one another by at least one coupling element. This solution provides a force-regulated, passive camber adjustment of the vehicle wheels. The tracking behavior of the vehicle wheel under the influence of a lateral force can be regulated passively.

### SUMMARY OF THE INVENTION

The purpose of the present invention is to provide an independent wheel suspension for a motor vehicle, which comprises passive tracking adjustment and with which the tracking behavior of the vehicle wheel can be regulated actively.

An independent wheel suspension for a motor vehicle, in which at least a first and at least a second link arm are each articulated to a wheel carrier supporting a vehicle wheel and which comprises compensation means for the correction of wheel positions, such that at least the first and second link arms comprise compensation means or are connected to compensation means and at least two compensation means of any wheel are connected with one another by at least one coupling element, has been developed further by the invention to the effect that a wheel position of at least one of the vehicle's wheels that deviates from the neutral position can be sensed by a sensor unit, consisting of a measured-value emitter and a measured-value receiver, which is arranged on or associated with at least one of the compensation means of the vehicle wheel concerned.

In contrast to the designs known from the prior art, the invention comprises compensation means which are used for the sensor detection of the wheel position. The essential advantage is in particular that the sensitive electronic components involved do not have to be arranged directly on the wheel or in its immediate vicinity. Rather, the compensation means are located a distance away from the vehicle wheel sufficient, for example, to avoid damage to the sensors by dirt or mechanical or thermal effects. The position of the vehicle wheel is conveyed directly by the coupling of the compensation means to the link arms and can therefore be determined without delays. The signal so produced can be directly processed further. Thus, reaction times in the range of real time can be achieved.

A connection of more than one vehicle wheel of the motor vehicle to one another in order to provide simultaneous compensation of wheel positions is also an object of the invention. Preferably, the vehicle wheels on the left and on the right relative to the driving direction are coupled to one another.

In particular, the invention provides passive camber adjustment for the steered wheels.

Thanks to the camber variation of the vehicle wheels relative to the road in the negative range, by virtue of the invention the risk is greatly decreased in extreme driving situations (elevation of the lateral force). The driving behavior of a motor vehicle equipped with the invention can be varied at will, from “oversteer”, through “neutral behavior” to “understeer”. The contact area between the vehicle's tires and the road is optimized with such a design. This in turn leads to reduced tire wear, improved adhesion function and therefore an increase of the motor vehicle's driving safety and driving comfort.

The individual wheel suspension according to the invention can have mechanical or hydraulic, pneumatic or electric-motor-powered compensation means. However, mechanical and hydraulic designs are preferred because they can be implemented simply.

Also advantageous is a design of the invention in which the camber angle of the vehicle wheel is sensed by the sensor unit. Such angle measurement can be implemented inexpensively and in a technically simple manner, and provides very accurate values.

For the further processing of the measured values detected, it is in addition proposed that the signal received by the sensor unit should form the control signal for a control unit.

The control unit can pass on the values provided by the sensor unit to a central processing unit (CPU), where they can be used for various motor vehicle control processes and/or may have an active connection to an actuator coupled to the vehicle wheel in such manner that the actuator can be controlled by the control unit. The actuator is understood to be any control element in the wider sense, which acts upon the wheel by virtue of a path change so as to enable an adjustment of the vehicle wheel. For example, the actuator compensates movements of the vehicle wheel produced due to the camber.

Moreover, the actuators can be used for controlling individual wheels selectively, so that they can be steered by means of the actuators. Mechanical steering could thereby be made unnecessary.

In accordance with a further development of the invention, another idea is to make the actuator part of a tie-rod articulated to the vehicle wheel or at least to couple the actuator to the tie-rod. In this way the effect of the actuator can be exerted directly on the vehicle wheel.

An actuator can be for example a piston-cylinder unit or a linear motor.

Quite considerable advantages can also be achieved by virtue of the invention if the left, and the opposite, right vehicle wheel relative to the driving direction of the motor vehicle can be steered by means of a common steering mechanism. With such a design it is for example possible to detect the wheel position with only one sensor unit on a compensation means and use the value so sensed for correcting the vehicle wheels on both sides of the vehicle. This considerably reduces the cost and effort of measuring, and in all, fewer signals have to be processed, which also favors the processing speed.

Furthermore, the system described above can be advantageously improved if at least one steering component comprises superimposed gearing. In this context a steering component is for example, the steering shaft on the steering gear. A superimposed gear normally supplies additional torque to the steering. In accordance with the invention, however, the superimposed gearing can also be used to function as an actuator, so that the wheel position can be varied thereby.

In particular the last-described version of the invention may require an additional mechanical coupling to be provided between the left and right vehicle wheels, which can be formed for example by a link arm.

As compensation means, pivoting control elements can be used. As a pivoting control element, a wishbone having three attachment points can be used.

According to a further development of the concept of the invention, each of the pivoting control elements has hinges for connection to the link arms, to each coupling element and to the vehicle body. These articulated connections can be realized technically by various hinges or bearings, a sufficient choice of which is available. As examples only, slide bearings, rotary slide bearings, rotary hinges, ball joints, rubber-sleeved springs or other elastomeric bearings can be mentioned. The bearings or hinges have in each case one to three degrees of freedom.

Pivoting control elements of different dimensions are also within the scope of the invention in order to achieve a desired wheel position correction under the effect of lateral forces.

A preferred geometrical design of the pivoting control elements is for example such that on each side of the respective steered vehicle wheels, the distance between the upper (relative to the motor vehicle) connection points on the vehicle body side and the lower connection points of an upper pivoting control element, is larger than the distance between the upper connection points and the lower connection points, on the vehicle body side, of the other, i.e. the lower pivoting control element.

Likewise, the ratio of the separation of the vehicle-body-side, upper (relative to the motor vehicle) connection points of an upper pivoting control element, to the separation of the vehicle-wheel-side, upper connection points of the same upper pivoting control element, can be larger than the ratio of the separation of the vehicle-body-side, upper connection points to the separation of the vehicle-wheel-side upper connection points of the other, i.e. the lower pivoting control element.

By means of these design variants of the pivoting control elements, wheel position corrections similar to those known from double transverse control arm axles can be achieved by other means.

A hinged support can serve as the coupling element. The link arms, for example functioning as transverse control arms, are components of an independent wheel suspension according to the invention which, for its part, can be part of a multi-control element axle or a central control element axle. Moreover, the term “control element” should not be interpreted too narrowly for the purposes of the invention. It also includes components of a motor vehicle that fulfill the same function.

Below, the invention will be explained in more detail with reference to the attached drawings. The example embodiments illustrated do not impose any limitations on the variants shown, but rather serve only to explain some principles of independent wheel suspensions according to the invention. In the figures, the same components or ones of the same type are given the same indexes. To enable the functions according to the invention to be explained clearly, the figures show only very simplified representations in principle, omitting any components not essential for the invention itself. This, however, does not mean that such components are not present in an independent wheel suspension according to the invention.

### BRIEF DESCRIPTION OF THE DRAWINGS

The figures show:

FIG. 1: Schematic, simplified representation of an inclined independent wheel suspension with two compensation means on each side of the vehicle

FIG. 2: Schematic, simplified representation of an un-deflected independent wheel suspension with three compensation means on each side of the vehicle, and

FIG. 3: Schematic, simplified representation of an inclined independent wheel suspension with two compensation means on each side of the vehicle and with a connection between the vehicle wheels on the two sides of the vehicle

### DETAILED DESCRIPTION OF THE PREFERRED EMBODIMENTS

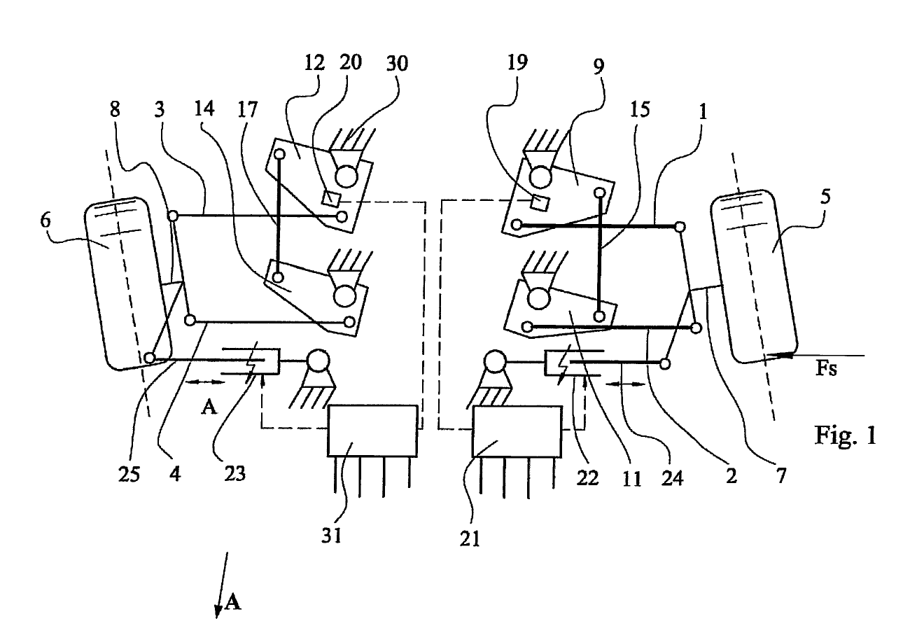

FIG. 1 shows a schematic and simplified representation of a first embodiment of an independent wheel suspension according to the invention, seen with the vehicle driving toward the viewer. In the figure, the wheel suspension is inclined because of a curve to the left. This means that the vehicle wheels 5, 6 are inclined relative to the vertical as happens for example when driving round a curve. In this case the wheels 5 and 6 are steered wheels. Relative to the driving direction indicated by the arrow “A” the independent wheel suspension comprises on each side two link arms 1, 2 and 3, 4 respectively. The vehicle wheel 5 is fixed on a wheel carrier 7 and the vehicle wheel 6 on a wheel carrier 8. Via the respective link arms 1, 2 and 3, 4, the two wheel carriers 7 and 8 are connected to compensation means 9, 11 and 12, 14. This articulated connection between the vehicle wheels 5, 6 and the compensation means 9, 11 and 12, 14 enables a direct transfer of the inclination of the vehicle wheels 5, 6 to the compensation means 9, 11 or 12, 14. In this context, pivoting control elements or wishbones can be used as the compensation means 9, 11, 12, 14. These have three connection points a, b, c each designed as a hinge. The pivoting control elements 9, 11 and 12, 14 on each side of the vehicle are in each case connected to one another by a coupling element 15 and 17 respectively. In each case a hinged support serves as the coupling element. By virtue of the linkage so formed, consisting of the link arms 1, 2 and the hinged support 15 for the left side of the vehicle with the vehicle wheel 5 and for the opposite, right side of the vehicle with the vehicle wheel 6 and the linkage comprising the link arms 3, 4 and the hinged support 17, synchronous mobility of the pivoting control elements 9, 11 and 12, 14 is ensured. In the variant shown in FIG. 1, respective sensor units 19 and 20 are arranged on the upper pivoting control elements 9, 12 of the two sides of the vehicle opposite one another. The sensor units 19, 20 are each connected to a respective control unit 21 or 31. In the present case each sensor unit consists of a measured-value emitter and a measured-value receiver, so that by means of the sensor unit the movement of the compensation means 9, 12 is detected. This can be done by an angle measurement device. The values so sensed are transmitted to the control unit 21 or 31. The signals can then be used to control an actuator 22 or 23 respectively. As active actuators, each actuator 22, 23 constitutes an adjustment device which is coupled, via a respective tie-rod 24 or 25, to the wheel support 7 or 8 of the respective independent wheel suspension. Thus, by means of the controllable active actuators 22 and 23 the wheel position can be influenced selectively. In addition to the camber of the vehicle wheels 5, 6 occurring while driving round a curve, the tracking behavior can be adjusted by the actuators 22, 23. Thus, in relation to increasing the driving safety, the behavior of the motor vehicle is decisively improved. The lateral force acting on the vehicle wheels 5, 6 is shown in FIG. 1 by the arrow Fs. All the connections between the wheel supports, compensation means, link arms and coupling elements are formed as articulated joints in this embodiment.

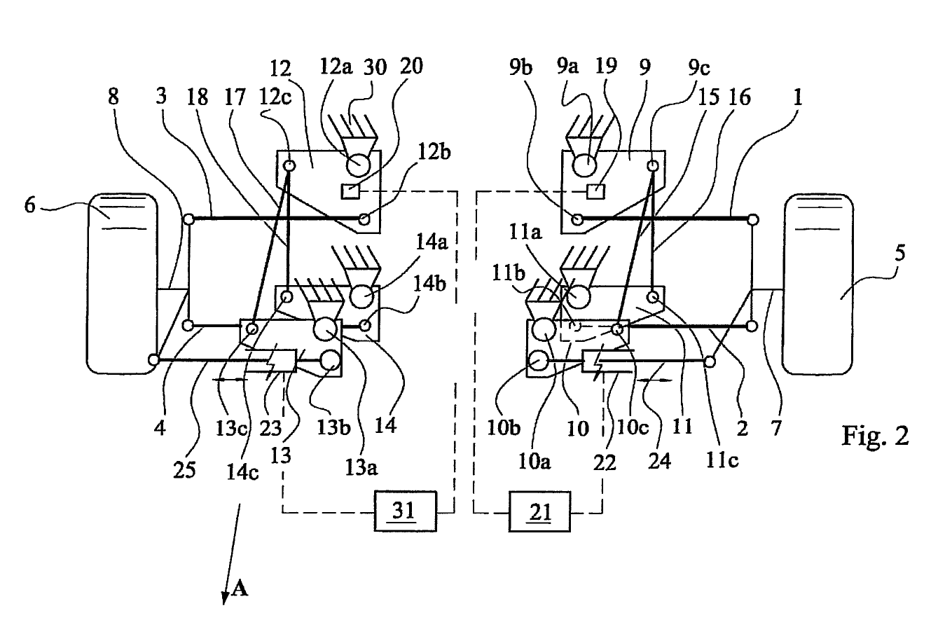

FIG. 2 shows an independent wheel suspension different from the one explained with reference to FIG. 1 (in this representation too, the vehicle is seen as driving toward the viewer). In contrast to FIG. 1, the independent wheel suspension shown here comprises a total of three respective compensation means 9, 10, 11 and 12, 13, 14. Here too, as the compensation means 9 to 14 pivoting control elements with three connection points a, b, c designed as hinges are used. The upper pivoting control element 9 is in this case connected via a hinged support 15, to the lower pivoting control element 10 and, via another hinged support 16, to the pivoting control element 11. On the right side of the motor vehicle relative to the driving direction of the motor vehicle indicated by the arrow “A” the pivoting control element 12 is connected, via a hinged support 17, to the lower pivoting control element 13 and, via a hinged support 18, to the pivoting control element 14. In the embodiment shown in FIG. 2, sensor units 19 and 20 are used on the upper pivoting control elements 9 and 12 respectively, so as to detect a position change of the vehicle wheel. Consequently, the sensor units 19 and 20 determine the angle adopted by each wheel 5 and 6 respectively. Only indicatively, FIG. 2 also shows the connection of the sensor units 19, 20 to associated control units 21, 31 which for their part pass the signal on to actuators 22 and 23. At the articulation points 9a, 10a, 11a and 12a, 13a, 14a the pivoting control elements 9, 10, 11 and 12, 13, 14 of the independent wheel suspension are in each case attached to the vehicle body. In this case actuators 22, 23 can be used which only have to move a small distance in order to change the position of the vehicle wheel 5, 6, this enabling a quicker and more precise reaction to changing influences.

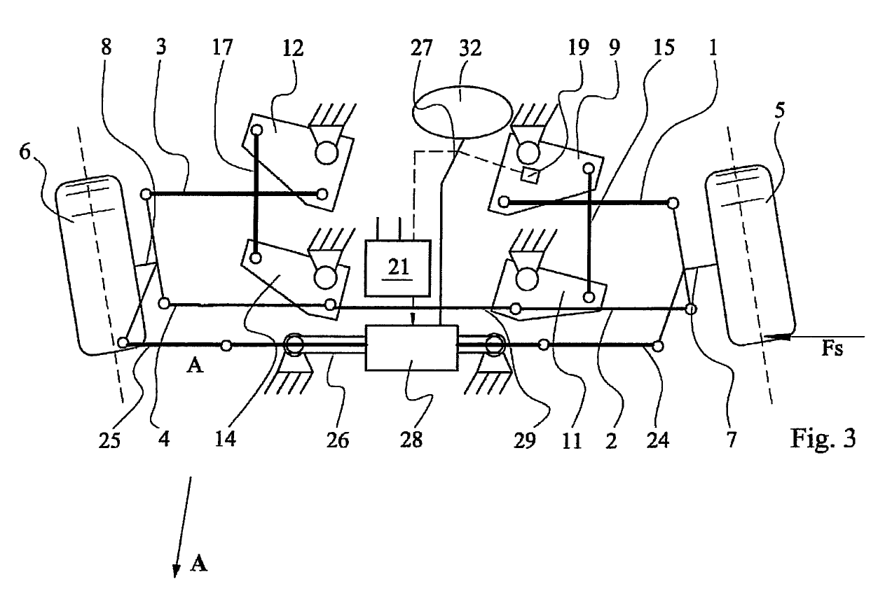

In turn, FIG. 3 shows a schematic, simplified representation of an inclined independent wheel suspension driving round a curve to the left toward the viewer, with only two pivoting control elements on each side of the vehicle and a connection between the vehicle wheels on the two sides of the vehicle. The special feature of this embodiment is in the present case that a connection is provided between the steered vehicle wheels 5, 6 opposite one another. This connection is formed by the steering gear system 26. The steering gear 26, accommodated in a steering gear housing in a manner known per se, is coupled to a steering shaft 27 whose other end supports the steering-wheel 32 of the motor vehicle. Thus, the steering movement applied by the vehicle's driver can be transmitted directly via, the steering shaft 27, to the steering gear 26. In this case the steering movement is then transmitted, via the tie-rods 24 and 25, to the vehicle wheels 5, 6, which are consequently deflected in the same direction. For this purpose the tie-rods 24 and 25 are articulated to the wheel carriers 7 and 8 respectively. A further special feature of the embodiment variant shown in FIG. 3 is also that only one sensor unit 19 and only one control unit 21 are needed, the sensor unit 19 in this case being provided on the pivoting control element 9, in order to detect the angular deviation of the vehicle wheel 5 or the vehicle wheel 6. As already explained earlier, the signal emitted by the sensor unit 19 is transmitted to the control unit 21 which, for its part, controls an actuator. In the present case a superimposed gear 28 is used as the actuator. With such a coupling between the steered wheels 5 and 6 on the left and right sides of the vehicle, it is an advantage if an additional mechanical coupling, in this case formed by a link arm 29, is provided.

### List of Indexes

1. Link arm
2. Link arm
3. Link arm
4. Link arm
5. Vehicle wheel
6. Vehicle wheel
7. Wheel carrier
8. Wheel carrier
9. Compensation means
10. Compensation means
11. Compensation means
12. Compensation means
13. Compensation means
14. Compensation means
15. Coupling element
16. Coupling element
17. Coupling element
18. Coupling element
19. Sensor unit
20. Sensor unit
21. Control unit
22. Actuator
23. Actuator
24. Tie-rod
25. Tie-rod
26. Steering gear
27. Steering shaft
28. Superimposed gear
29. Mechanical coupling/link-rod
30. Vehicle body
31. Control unit
32. Steering-wheel

1-19. (canceled)

20. An independent wheel suspension for a motor vehicle, in which at least a first and at least a second link arm (1, 2, 3, 4) are respectively articulated to a wheel carrier (7, 8) supporting a vehicle wheel (5, 6),
the first and the second link arms (1, 2, 3, 4) either compensation means (9, 10, 11, 12, 13, 14) or being connected to compensation means (9, 10, 11, 12, 13, 14),
at least two compensation means (9, 10 and 12, 13) of each wheel being connected to one another by at least one coupling element (15, 16, 17, 18),
a wheel position of at least one of the vehicle wheels (5, 6) that deviates from a neutral position is sensed by a sensor unit (19, 20) having a measured-value transmitter and a measured-value receiver arranged on at least one of the compensation means (9, 10, 11, 12, 13, 14) of the vehicle wheel (5, 6) concerned or associated with at least one of the compensation means (9, 10, 11, 12, 13, 14).

21. The independent wheel suspension according to claim 20, wherein a camber angle of the vehicle wheel (5, 6) is sensed by the sensor unit (19, 20).

22. The independent wheel suspension according to claim 20, wherein a signal, received by the sensor unit (19, 20), forms a control signal for an other control unit (21, 31).

23. The independent wheel suspension according to claim 22, wherein the other control unit (21, 31) is actively connected to an actuator (22, 23) coupled to the vehicle wheel (5, 6).

24. The independent wheel suspension according to claim 23, wherein either the actuator (22, 23) is part of a tie-rod (24, 25) articulated to the vehicle wheel (5, 6) or the actuator (22, 23) coupled to the tie-rod (24, 25).

25. The independent wheel suspension according to claim 24, wherein the actuator is one of a piston-cylinder unit and a linear motor.

26. The independent wheel suspension according to claim 20, wherein the left vehicle wheel (5) and the opposite, right vehicle wheel (6) are steered by a common steering gear system (26), relative to a driving direction of the motor vehicle.

27. The independent wheel suspension according to claim 26, wherein at least one steering component (26, 27) has a superimposed gear (28).

28. The independent wheel suspension according to claim 26, wherein an additional mechanical coupling (29) is located between the left and the right vehicle wheel (5, 6).

29. The independent wheel suspension according to claim 20, wherein the compensation means (9, 10, 11, 12, 13, 14) are pivoting control elements.

30. The independent wheel suspension according to claim 29, wherein the pivoting control elements (9, 10, 11, 12, 13, 14) are wishbones and each have three connection points (a, b, c).

31. The independent wheel suspension according to claim 29, wherein each pivoting control element (9, 10, 11, 12, 13, 14) has hinges (a. b, c) for connection to the link arms (1, 2, 3, 4), to each coupling element (15, 16, 17, 18), and to a vehicle body (30).

32. The independent wheel suspension according to claim 31, wherein the hinges (a, b, c) are one of rotary joints and elastomeric bearings.

33. The independent wheel suspension according to claim 29, wherein the pivoting control elements (9, 10, 11, 12, 13, 14) have different dimensions.

34. The independent wheel suspension according to claim 29, wherein on each side of the left and the right vehicle wheels (5, 6), a separation between vehicle-body-side upper connection points (9a, 12a), relative to the motor vehicle, and lower connection points (9b, 12b) of an upper pivoting control element (9, 12) is larger than a separation between the vehicle-body-side upper connection points (10a, 11a or 13a, 14a) and lower connection points (10b, 11b or 13b, 14b) of an other, lower pivoting control element (12, 13 or 14, 15).

35. The independent wheel suspension according to claim 34, wherein a ratio of the separation of vehicle-body-side upper connection points (9a, 12a), relative to the vehicle, of the upper pivoting control element (9, 12) to the separation of the vehicle-wheel-side upper connection points (9c, 12c) of the same upper pivoting control element (9, 12), is larger than a ratio of the separation of the vehicle-body-side upper connection points (10a, 11a or 13a, 14a) to the separation of the vehicle-wheel-side upper connection points (10c, 11c or 13c, 14c) of the other, lower pivoting control element (10, 11 or 13, 14).

36. The independent wheel suspension according to claim 20, wherein at least one coupling element (15, 16, 17, 18) is a hinged support.

37. The independent wheel suspension according to claim 20, wherein the first and the second link-arms (1, 2, 3, 4) are transverse control arms.

38. The independent wheel suspension according to claim 20, wherein the independent wheel suspension is part of one of a multi-link axle and a central-link axle.
